(19) United States
(12) Patent Application Publication
(10) Pub. No.: US 2025/0134008 A1
(43) Pub. Date: May 1, 2025

(54) FLOWER HOLDER ASSEMBLY

(71) Applicant: David Swift, Los Angeles, CA (US)

(72) Inventor: David Swift, Los Angeles, CA (US)

(21) Appl. No.: 18/415,414

(22) Filed: Jan. 17, 2024

Related U.S. Application Data
(60) Provisional application No. 63/545,829, filed on Oct. 26, 2023.

(51) Int. Cl. A01G 5/04; B65D 25/22; B65D 85/50

(52) U.S. Cl. CPC A01G 5/04; B65D 25/22; B65D 85/505

(57) ABSTRACT

A flower holder assembly. The flower holder assembly includes a body with an inner volume into which a bouquet of flowers may be placed. The assembly also includes arms that extend outward from the body that are used to attach the assembly to the side of a shopping cart and/or to the seat back pocket within a vehicle. When configured with a shopping cart, the flowers may be held generally vertical, and when configured with a seat back pocket, the flowers may be held at a reclined angle to protect the flowers from bumping into the back of the seat and becoming damaged.

### CROSS-REFERENCE TO RELATED APPLICATIONS

This application is a non-provisional application which claims priority to U.S. Provisional Patent Application No. 63/545,829 filed on Oct. 26, 2023, which is incorporated by reference in its entirety for all purposes.

### FIELD OF THE INVENTION

This invention relates to holders, including holders for flowers.

### BACKGROUND

Bouquets of fresh flowers are sold throughout the world in a wide variety of retail stores. In fact, because fresh flowers are such a high selling item, flower bouquets are commonly sold in food markets (e.g., supermarkets). While shopping in these types of stores, a customer may choose a bouquet of flowers to purchase, and may place the bouquet into a shopping cart while he/she may continue to shop for other items. Then, when it is time to transport the flowers home, the customer may typically lay the flowers down on a seat within his/her car (e.g., on a vacant passenger-side seat and/or in the back seat of the car) in an effort to keep the flowers from becoming damaged during the ride home.

However, placing the flowers within the shopping cart while shopping may put the flowers at risk of being pressed or otherwise damaged by other items within the cart. And placing the flowers on their side during the ride home may cause the flowers to become lopsided. The flowers also may easily fall from the seat onto the floor during movement of the car.

Accordingly, there is a need for a flower holder assembly that may hold the flowers safe from damage within a shopping cart and within a vehicle.

### SUMMARY

According to one aspect, one or more embodiments are provided below for a flower holder assembly comprising a holder body including an open top and a bottom defining a body longitudinal axis, and a front and a back defining a body inner volume, one or more arms coupled to and extending outward from the front of the holder body, each one of the one or more arms including a distal end and a first notch in a bottom side of the distal end, wherein the first notch includes a first notch distal sidewall that defines a first notch longitudinal axis, the first notch longitudinal axis at a notch offset angle with respect to the body longitudinal axis.

In another embodiment, the notch offset angle includes an acute angle with respect to the body longitudinal axis.

In another embodiment, each one of the one or more arms includes a second notch in the bottom side and located between the front of the holder body and the first notch.

In another embodiment, the second notch includes a second notch distal sidewall that defines a second notch longitudinal axis, the second notch longitudinal axis substantially parallel to the holder longitudinal axis.

In another embodiment, the one or more arms are removable from the holder body.

In another embodiment, a portion of the one or more arms pass through the front and the back of the flower holder body.

In another embodiment, the flower holder assembly comprises a positioning member within the body inner volume that urges a flower bouquet held within the holder inner volume towards the back of the flower holder body.

In another embodiment, the positioning member includes a portion of the front of the holder body folded inward into the holder inner volume and/or a portion of the back of the holder body folded inward into the holder inner volume.

In another embodiment, the positioning member includes a line.

In another embodiment, the flower holder assembly comprises a shelf within the body inner volume substantially perpendicular to the body longitudinal axis.

In another embodiment, the holder body is collapsible.

In another embodiment, the one or more arms is retractable. According to another aspect, one or more embodiments are provided below for a flower holder assembly comprising a holder body including an open top and a bottom defining a body longitudinal axis, and a front and a back defining a body inner volume; one or more arms coupled to and extending outward from the front of the holder body, each one of the one or more arms including a distal end and a first notch in a bottom side of the distal end; wherein the first notch includes a first notch distal sidewall that is at least 3″ from the front of the holder body.

In another embodiment, the first notch includes a first notch distal sidewall that defines a first notch longitudinal axis, the first notch longitudinal axis at an acute angle with respect to the body longitudinal axis.

In another embodiment, each one of the one or more arms includes a second notch in the bottom side and located between the front of the holder body and the first notch.

In another embodiment, the second notch includes a second notch distal sidewall that defines a second notch longitudinal axis, the second notch longitudinal axis substantially parallel to the holder longitudinal axis.

In another embodiment, the one or more arms are removable from the holder body.

In another embodiment, a portion of the one or more arms pass through the front and the back of the flower holder body.

In another embodiment, the flower holder assembly comprises a positioning member within the body inner volume that urges a flower bouquet held within the holder inner volume towards the back of the flower holder body.

In another embodiment, the holder body is collapsible, and the one or more arms is retractable.

Other aspects and advantages of the invention will be apparent from the following description and the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIGS. 1-4 shows aspects of a flower holder assembly according to exemplary embodiments hereof;

FIGS. 5-6 show aspects of a flower holder assembly arm according to exemplary embodiments hereof;

FIG. 7 shows aspects of a flower holder assembly arm according to exemplary embodiments hereof;

FIGS. 8-9 show aspects of a flower holder positioning mechanism according to exemplary embodiments hereof;

FIG. 10 shows aspects of a flower holder assembly inner shelf according to exemplary embodiments hereof;

FIGS. 11-12 show aspects of a flower holder assembly according to exemplary embodiments hereof; and

FIGS. 13-14 show aspects of a collapsible flower holder assembly according to exemplary embodiments hereof.

### DETAILED DESCRIPTION OF EXEMPLARY EMBODIMENTS

In general, the assembly according to exemplary embodiments hereof includes a flower holder assembly. The flower holder assembly may be designed to hold one or more flowers generally upright and/or at a desired offset angle. For example, the flower holding assembly may be configured to hold a bouquet of flowers generally upright within a shopping cart at a store. In another example, the flower holding assembly may be configured to hold the bouquet of flowers at a desired offset angle within a vehicle (e.g., attached to the seat back pocket behind the front driver's seat) while transporting the bouquet home from the store. The reason for the offset angle will be described herein. As described herein, the flower holder assembly may be configured in a variety of settings to generally secure and hold flowers.

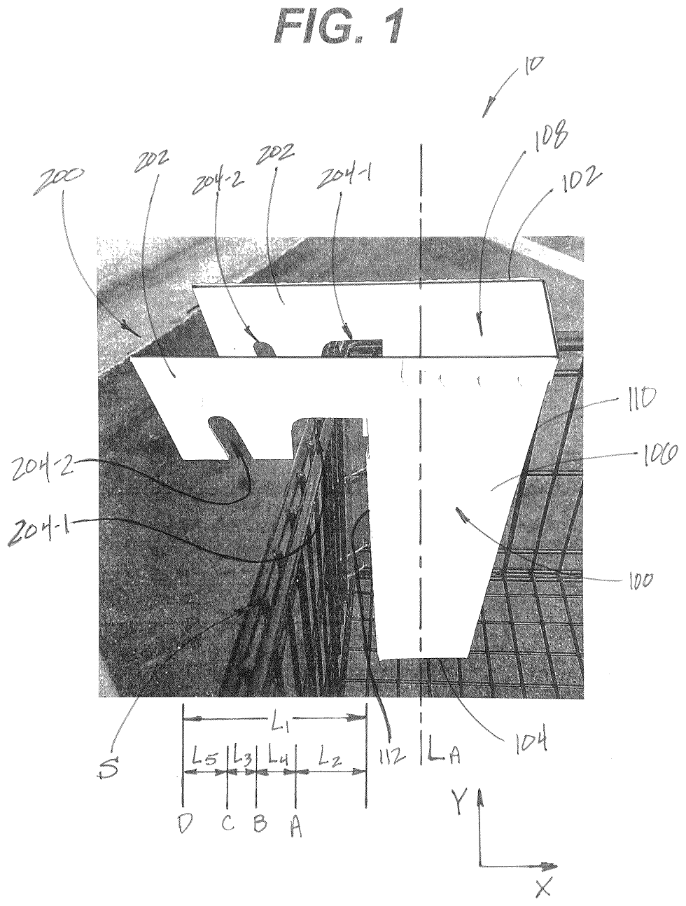

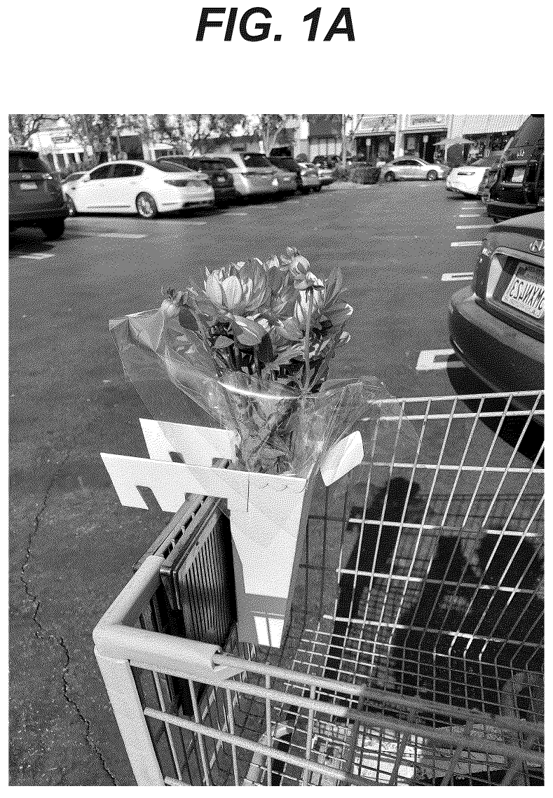

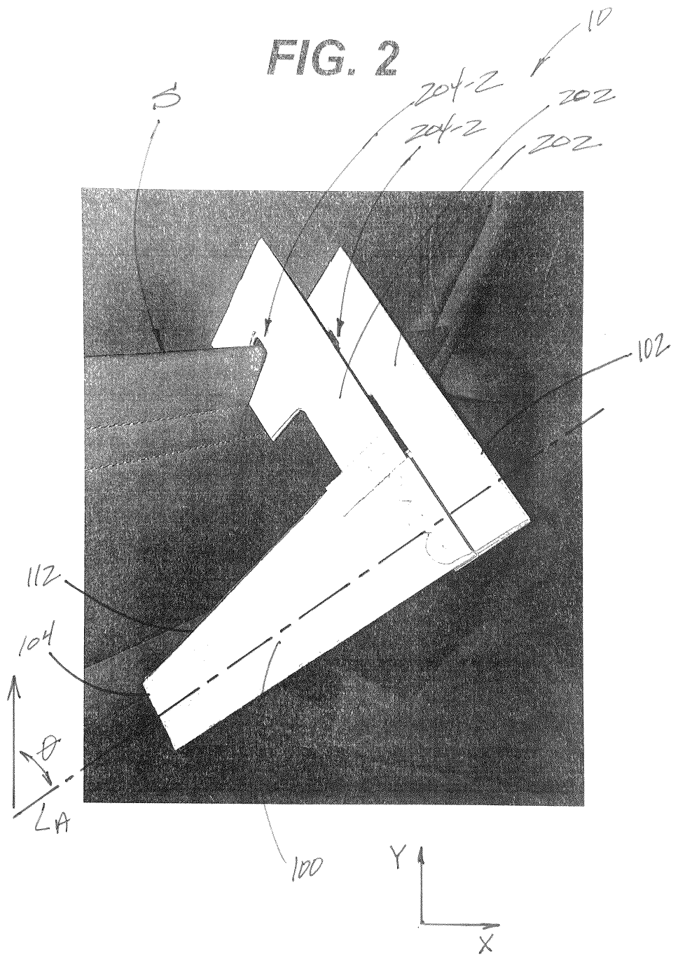

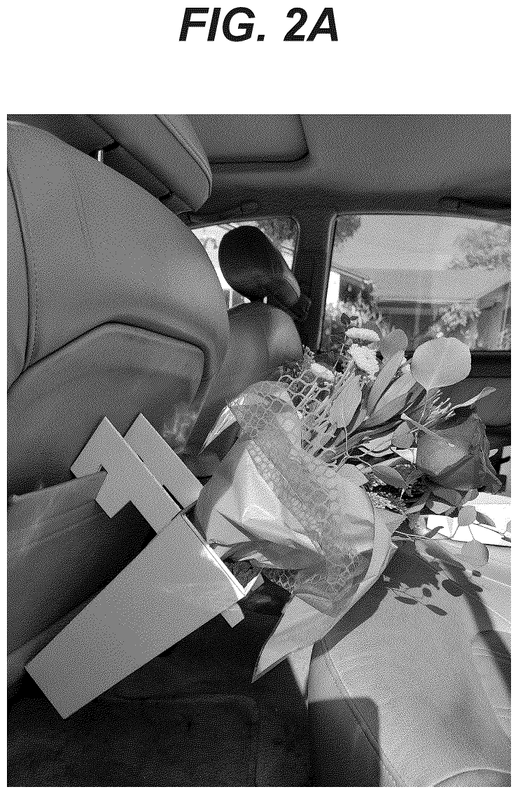

FIGS. 1 and 2 show side perspective views of a flower holder assembly 10 (also referred to herein as simply the assembly 10) according to exemplary embodiments hereof. As shown, the flower holder assembly 10 may be designed to generally hang upon and thereby be configured with a support structure S. For example, as shown in FIG. 1, the support structure S may include a top edge of a shopping cart side wall, and as shown in FIG. 2, the support structure S may include an upper lip of a seat back pocket of an automobile. FIG. 1A shows a flower bouquet held within the assembly 10 of FIG. 1 with the flower spray extending generally vertically upward from the top of the assembly 10, and FIG. 2A shows a flower bouquet held within the assembly 10 of FIG. 2 with the flower spray extending away from the back of the car seat such that the flowers do not rest against or bump into the back of the car seat while driving. This positioning may generally protect the bouquet of flowers from damage during the ride.

In some embodiments, as shown in FIGS. 1 and 2, the flower holder assembly 10 includes a flower holder body 100, and an attachment assembly 200. In general, a bouquet of flowers (or similar) may be placed into the flower holder body 100 to be held therein, and the attachment assembly 200 may be used to configure the assembly 10 a support structure S. The assembly 10 may include other elements as necessary to fulfill its functionalities.

For the purposes of this specification, the flower holder assembly 10 will be described primarily with respect to being configured with a shopping cart and with a seat back pocket as shown in FIGS. 1 and 2. It is understood however that the assembly 10 may be configured with other types of support structures S (preferably with a top edge or lip) and that the scope of the assembly 10 is not limited in any way by the type(s) of support structures S that it may be configured with. The flower holder assembly 10 also will be described primarily with respect to its use in holding and securing a bouquet of flowers, however, it is understood that the assembly 10 also may be used to hold other items.

### Flower Holder Body 100

In some embodiments, as shown in FIG. 1, the flower holder body 100 includes a top end 102 and a bottom end 104 defining a body longitudinal axis L_{A}, and sidewalls 106 generally extending from the top end 102 to the bottom end 104 thereby defining a body inner volume 108. The flower holder body 100 also may include a back side 110 and a front side 112 generally opposite the back side 110. The sidewalls 106 may include any number of distinct sidewalls depending on the shape and form of the body 100. For example, with the body 100 of FIG. 1 having a generally square or rectangular cross-sectional shape along the longitudinal axis L_{A}, the body 100 may include four sidewalls 106. However, in other embodiments, the body 100 may include a circular or oval cross-sectional shape such that the sidewall 106 may include a single continuous sidewall extending about the outer circumference of the body 100. Other cross-sectional shapes also are contemplated, such as triangular, trapezoidal, polygonal, etc., resulting in other numbers of sidewalls 106. In some embodiments, the height of the body 100 from its top 102 to its bottom 104 may be about 8″ to 24″, and preferably about 11.5″ to 24″. In some embodiments, the width of the top 102 of the flower holder body 100 may be about 3″ to 7″ and preferably about 3½″ to 4½″, and the width at the bottom 104 of the holder 100 may be about 1″ to 6″, and preferably about 2″ to 3″.

It also is understood that the holder body 100 may be provided in different sizes depending on the application. As will be described herein, a flower bouquet may be placed into the body inner volume 108 and held therein.

In some embodiments, the flower holder body 100 may comprise cardboard (or other suitable materials) such that it may be die-cut as a flat sheet and folded or otherwise manipulated to form the body 100. In other embodiments, the body 100 may be formed of plastic, metal, glass, ceramic, wood, composite materials, other suitable materials, and/or any combinations thereof. For example, in some embodiments, the body 100 may be molded using plastic or formed of sheet metal.

In some embodiments, it may be preferable that the flower holder body 100 be watertight and/or waterproof such that water from the bouquet of flowers may not saturate, pass through the material of the body 100 (e.g., leak out), or otherwise damage the flower holder body 100 in any way. For example, if the body 100 is formed of cardboard, it may be preferable that the cardboard include a waterproof coating, or a sheet of waterproof material laminated or otherwise attached to the surface of the material that may face into the body's inner volume 108 when the body 100 is formed. The outside of the assembly 10 also may be similarly waterproofed for protection from rain and other moister. In another example, a water-tight cup (or similar) may be configured within the inner volume 108 at the bottom 104 the flower holder body 100. In yet another example, if the body is molded of plastic, it may be preferable that the plastic be waterproof such that any water within the inner volume 108 may not leak out of the body 100.

### Attachment Assembly 200

In some embodiments, as shown in FIG. 1, the attachment assembly 200 may include one or more arms 202, with each arm 202 including one or more notches 204 (also referred to as hooks). In a preferred embodiment, the assembly 200 may include a total of two arms 202 as shown. A proximal end of each arm 202 may be coupled to the flower holder body 100, e.g., with a first arm 202 coupled to the left side of the body's front 112 and a second arm 202 coupled to the right side of the body's front 112, each at a location at or near the top 102 of the body 100. The distal end of each arm 202 may extend outward from the body 100 to enable the body 100 to be attached to a support structure S. It may be preferable that the first and second arms 202 be generally parallel with respect to one another and of equal length. It also may be preferable that the first and second arms 202 each extend outward generally perpendicular to the body's longitudinal axis L_{A}.

In some embodiments, as shown in FIG. 1, each arm 202 may extend outward from the front 112 of the flower holder body 100 a total distance L₁. In addition, each arm 202 may include a first notch 204-1 in its lower edge that extends generally from or near the front 112 of the holder body 100 outward a distance L₂ on the arm 202 to a first location A. Each arm 202 also may include a second notch 204-2 in its lower edge that extends a distance L₃ from a second location B to a third location C on the arm 202. This may leave a section of material at the bottom edge of each arm 202 that extends a distance L₄ between the first and second notches 204-1, 204-2 on each arm 202, i.e., from position A to position B. In addition, each arm 202 may extend outward a distance L₅ from the end of its respective second notch 204-2 at position C to the far distal end of each arm 202 at position D.

In some embodiments, the first notches 204-1 may be utilized to attach the assembly 10 to a side of a shopping cart (see FIGS. 1 and 1A), and the second notches 204-2 may be utilized to attach the assembly 10 to the upper lip of a car seat back pocket (see FIGS. 2 and 2A). Given that the first and second arms 202 (and their respective notches 204-1, 204-2) are separated from one another, e.g., by the width of the flower holder body 102, the arms 202 and notches 204-1, 204-2 provide lateral support to the flower holder body 102 so that it may not easily swivel or pivot about the notches 204-1, 204-2 when hanging from support structure S.

In addition, it may be preferable that the first notches 204-1 when used to configure the assembly 10 with a shopping cart set the longitudinal axis L_{A} of the flower holder body 100 generally upright and generally parallel to the Y-axis. As such, each first notch 204-1 may include proximal and distal first notch sidewalls (that generally define the first notch 204-1) that are substantially parallel to the longitudinal axis L_{A} of the flower holder body 100. In this embodiment, the term substantially parallel to the longitudinal axis L_{A} means first notch proximal an distal sidewalls that are within about 20° of the longitudinal axis L_{A} means and more preferably within about 5° longitudinal axis L_{A}.

It also may be preferable that the second notches when used to configure the assembly 10 with the seat back pocket within an automobile set the longitudinal axis L_{A} at an outward offset angle with respect to the Y-axis. In this way, the bouquet of flowers may be held away from the back of the car seat such that the flowers may not rest against or bump into the back of the car seat while driving. This positioning may generally protect the bouquet of flowers from damage during the ride.

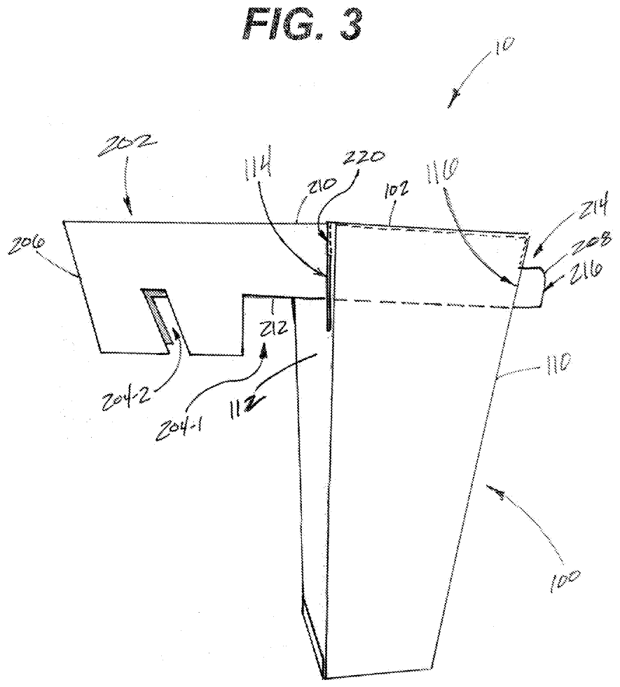

In some embodiments, as shown in FIGS. 3-5, the first and second arms 202-1, 202-2 may each be attachable and/or removable from the flower holder body 100. By removing the arms 202, the assembly 10 may be more easily folded into a compact configuration for stowage. In addition, without the arms 202-1, 202-2 attached, the flower holder body 100 may be used as a standalone vase (e.g., as a gift, etc.).

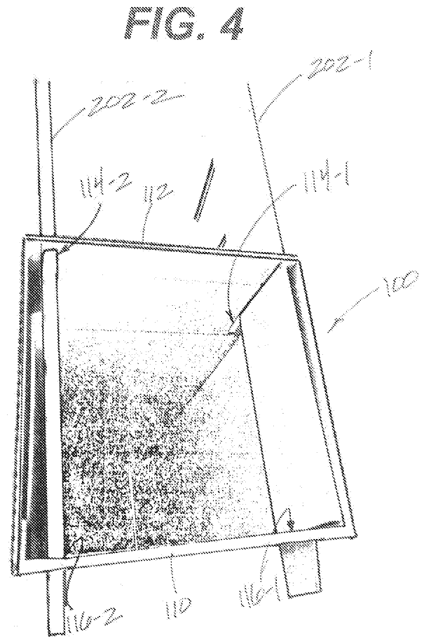

For example, in some embodiments, as shown in FIGS. 3-4, the flower holder body 100 may include one or more frontside slots 114 and one or more corresponding backside slots 116 designed to each receive and hold a portion of one or more corresponding arms 202.

In a preferred embodiment, the flower holder body 100 may include a first frontside slot 114-1 in its front side 112 at or near its left side, and a second frontside slot 114-2 in its front side 112 at or near its right side. Similarly, the flower holder body 100 also may include first and second backside slots 116-1, 116-2 on its back side 110 at or near its left or rights sides, respectively. The slots 114, 116 may each extend from a position near the top 102 of the body 100 downward (preferably linearly) to a lower position. As will be described below, the frontside and backside slots 114, 116 may receive the attachable arms 202 and removably secure the arms 202 to the flower holder body 100 for use.

In some embodiments, as shown in FIG. 5, the first and second arms 202-1, 202-2 may each include an elongate section of material (e.g., cardboard, or similar) including a front end 206, a back end 208, a top side 210, and a bottom side 212. In addition, the back end 208 may include an upper notch cutout 214 leaving a lower tab 216 of height H₁ on the distal back end 208 of the arm 202.

In some embodiments, a portion of each arm 202 is designed to pass through a respective flower holder body's frontside and backside slots 114, 116 and be held therein.

To configure the first arm 202-1 with the flower holder body 100, the first arm's back end 208 may first be guided through the body's first frontside slot 114-1 (e.g., on the left side of the flower holder body 100). The arm 202-1 may be pushed further through the frontside slot 114-1 until the lower tab 216 at the back end 208 of the arm 202-1 may enter and pass through the flower holder body's first backside slot 116-1. In some embodiments, the lower tab 216 may include a relief angle 218 at its upper outer corner to aid in the insertion of the tab 216 into the backside slot 116-1.

Given the above, it may be preferable that the body's first frontside slot 114-1 have a height generally equal to (or greater than) the height H₂ of the first arm 202-1 and that the body's first backside slot 116-1 have a height generally equal to (or greater than) the height H₁ of the arm's back end lower tab 216. In addition, it also may be preferable that the top end of the first backside slot 116-1 be positioned on the back side 110 of the flower holder body 100 a distance below the top 102 of the body equal to the height H₃ of the arm's upper notch cutout 214. In this way, the arm's lower tab 216 may pass through the backside slot 116-1 and the upper notch cutout 214 may generally abut against the inner sidewall of the body's back side 110 above the slot 116-1. This may place the top 210 of the arm 202-1 at or near its back end 208 to be generally flush with the top 102 of the flower holder body 100.

In addition, as shown in FIG. 5, the first arm 202-1 may include a slot 220 of height H₄ in its top side 210 designed to engage and receive a portion of the flower holder body's front side 112 above the body's frontside notch 114-1 when the arm's upper notch cutout 214 abuts against the inner sidewall of the body's back side 110 (as described above). Accordingly, it may be preferable that the top end of the frontside notch 114-1 be positioned on the front side 112 of the flower holder body 100 a distance below the top 102 of the body equal to the height H₄ of the arm's topside slot 220. This engagement is shown in FIG. 3. As shown, this may place the top 210 of the arm 202-1 at or near the top 102 of the flower holder body 100 in the area of the slot 220. Furthermore, because the top 210 of the arm 202-1 at its back end 208 and in the area of its slot 220 are both flush with the top 102 of the flower holder body 100, the top 210 of the arm 202-1 may be generally aligned with the top 102 of the holder body 100 across the entire top 102 of the holder body 100. This also places the arm 202-1 at a generally perpendicular orientation with the flower holder body's longitudinal axis L_{A} (see FIG. 1). It also is contemplated that the top 210 of the arm 202-1 be offset below the top 102 of the flower holder body 100 such that the top 102 of the flower holder body 100 extends above the top 210 of the arm 202-1.

Given the above, a procedure to configure the first arm 202-1 with the flower holder body 100 may include the following actions. First, the back end 208 of the first arm 202-1 may be inserted through the flower holder body's first frontside slot 114-1. The arm 202-1 may be pushed further through the slot 114-1 until the arm's lower backend tab 216 passes through the body's backside slot 116-1. This may place the back of the arm's backend upper notch cutout 214 against the inner sidewall of the body's back side 110 in the area above the backside slot 116-1. This also may generally align the arm's topside slot 220 at the top end of the body's frontside notch 114-1. Once in this position, the arm 202-1 may then be pushed upward so that the portion of the body's front side 112 above frontside notch 114-1 enters into the arm's topside slot 220 and is held therein (e.g., by pressure fit). This may place the arm 202-1 in the aligned configuration with the flower holder body 100 as described above.

It is understood that the second arm 202-2 may be configured with the flower holder body's second frontside and backside slots 114-2, 116-2 in the same or similar fashion, and as such, that description will not be described herein to avoid redundancy.

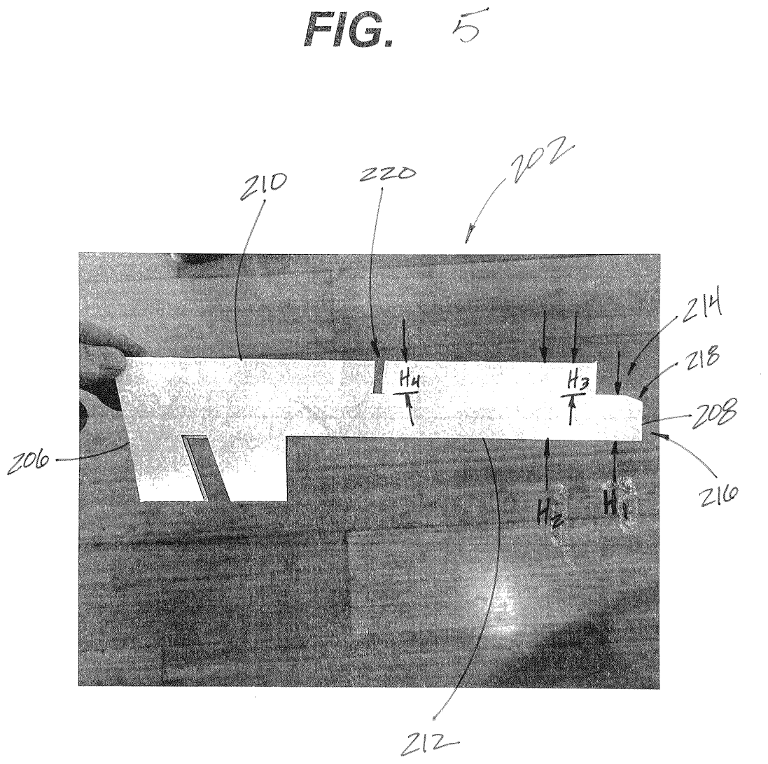

FIG. 6 shows additional preferred specifications (dimensions, angles, etc.) of an exemplary arm 202. Below are descriptions of these specifications.

A: Length of the arm 202 from its distal front end 206 to its upper side slot 220. This length A generally determines the length of the arm 202 that extends outward from the flower holder body's front side 112. Looking at FIG. 6 with respect to FIG. 2, it can be seen that the length A sets the distance between the flower holder body 100 (and thus a bouquet of flowers within the body 100) and the back of the car seat. In some embodiments, for standard sized bouquets of flowers, the length A may preferably be about 3″ to 7″, and more preferably about 4″ to 6″, and more preferably about 4⅝″.

B: Length of the arm 202 from its upper side slot 220 to its back end 208. This length may generally correspond to the width of the flower holder body 100 from its front 112 to its back 110 and may allow for the arm's lower backend tab 216 to extend beyond the back 110 of the holder 100 an adequate distance for support and strength. In some embodiments, for standard sized bouquets of flowers, the length B may preferably be about 4″ to 5″ and more preferably about 4¼″, and for smaller sized bouquets, the length B may preferably be about 5″ to 6″ and more preferably about 5¼″.

C: Length of the section of material separating the first notch 204-1 and the second notch 204-2. To ensure structural integrity of the arm 202, it may be preferable that the length C be at least ½″.

D: Vertical height of the first notch 204-1 and/or the second notch 204-2. In some embodiments, this the height D may preferably be about 1″ to 2″, and more preferably about 1¼″.

E: Width of the first notch 204-1. Because the first notch 204-1 may be utilized to receive the top edge of a shopping cart side wall, and these side walls may vary in width from cart to cart (e.g., some may comprise steel, wider plastic, additional frames with advertisement plaques, etc.), the width E may preferably be about 1″ to 3″, and preferably about 1⅞″ wide. It also is understood that other dimensions may be used to customize the notch 204-1 to a particular shopping cart or other structure.

F: Length of the lower tab's upper portion that includes the relief angle 218. The length F may preferably be about ½″ long at an angle of about 20° with respect to horizontal. In addition, the horizontal portion of the notch cutout 214 between the length F and the vertical portion of the notch cutout 214 is preferably equal to or greater than the thickness of the front wall of the flower holder body 100 through which it extends.

G: Angle of the arm's top slot 220 inner side wall closest to the back 208 of the arm 202 with respect to horizontal. This angle provides a wider width at the top of the slot 220 compared to the width of the slot 220 at its bottom. In this way, the portion of the flower holder body 100 received into the slot 220 may fit easily into the top of the slot 220 and may fit snug at the bottom of the slot 220. In some embodiments, the angle G may be about 80° with respect to horizontal (about 10° from vertical).

H: Height of the arm's top slot 220. In some embodiments, the height H may generally match the distance between the top 102 of the flower holder body 100 and the top end of the holder's frontside slot 220. To maintain structural integrity of the arm 202, it may be preferable for the height H be no greater than about 45% of the height P (which may correspond to the height H₂ of FIG. 5). In some embodiments, the height H may be about ⅝″.

J: Height of the arm's upper notch cutout 214. In some embodiments, the height J may generally match the height H such that the arm 202, when secured to the flower holder body 100 be generally perpendicular to the holder's longitudinal axis L_{A}. As such, in some embodiments, the height J may be about ⅝″.

K: Width of the portion of the arm 202 between the second notch 204-1 and the arm's distal front end 206. The width K may generally provide a width of arm material (e.g., cardboard) that may be received into the car seat back pocket such that the front end 206 of the arm 202 may abut against the back of the driver's seat (see FIG. 2). This width K received into the car seat back pocket may generally wedge the distal end of the arm 202 into the pocket thereby holding the assembly 10 stable. In some embodiments, the width K may preferably be greater than 1″, and more preferably about 1⅛″.

L: Distance from the arm's top notch inner side wall closest to the front 206 of the arm 202 and the beginning of the second notch 204-2. When the arms 202 are configured with the flower holder body 100, the distance L also equates to the distance between the front 112 of the flower holder body 100 to the beginning of the second notch 204-2. This sets the distance between the flower holder body 100 (and thus a bouquet of flowers within the body 100) and the outer flap of the car seat back pocket. In some embodiments, for a standard sized bouquet of flowers, the distance L is about 3″ or greater. For smaller bouquets of flowers, the distance L may be less.

M: Height of the arm 202 in the area of the notches 204-1, 204-2. In some embodiments, the height M is about 2″ to 4″, and more preferably about 2¾″.

P: Height of the arm 202 in the area of the arm 202 that passes through the flower holder body's first and second slots 114, 116. In some embodiments, e.g., when cardboard or a similar material is used, the height P is about 1″ to 2″, and more preferably about 1½″. Lesser values may be used for stronger materials.

Q: Angle of the second notch 204-2 inner sidewalls with respect to horizontal. In some embodiments, with the top lip of the outer flap of the car seat back pocket received into the second notch 204-2 as shown in FIG. 2, the angle Q at least partially sets the flower holder body's longitudinal axis L_{A} at a reclined angle θ with respect to vertical. In this way, the top 102 of the holder body 100 may be angled away and held at a distance (e.g., a distance L) from the seat back pocket, and the front 112 of the flower holder body 100 at its bottom 104 may rest against the outer lower region of the seat back pocket as shown in FIG. 2 thereby providing lower support to the assembly 10. In this arrangement, a bouquet of flowers may be placed within the holder's inner volume 108 with the bouquet's spray of flowers extending out the top 102 of the holder body 100 and away from the back of the seat to prevent damage thereto as shown in FIG. 2A. In some embodiments, the angle θ preferably may be about 10° to about 60°, and more preferably about 15° to about 50°, and more preferably about 20°.

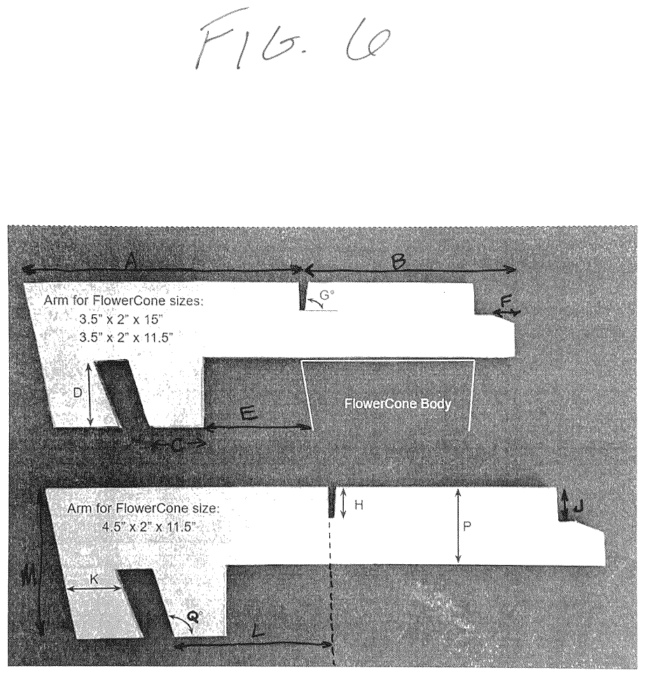

In some embodiments, the arms 202 may include an alternative notch architecture as shown in FIG. 7. In the upper example shown, the arm notch 204 may include a single notch with a stepped height such that a portion of the notch 204 closest to the front 112 of the flower holder body 100 may be taller than the portion of the notch 204 further away from the holder's front side 112. In the lower example shown, the arm notch 204 may include a single notch with a stepped height such that a portion of the notch 204 closest to the front 112 of the flower holder body 100 may be shorter than the portion of the notch 204 further away from the holder's front side 112. Other stepped notch configurations also are contemplated.

In some embodiments, when a bouquet of flowers is held within the assembly 10 and configured with the car back seat pocket as shown in FIG. 2A, it may be preferable that the bouquet be urged towards the back side 110 of the flower holder body 100 to further position and hold the flower spray away from the back of the car seat. To accomplish this, in some embodiments, the flower holder body 100 may include a positioning mechanism 118 within its inner volume 108 that may physically engage the flower bouquet.

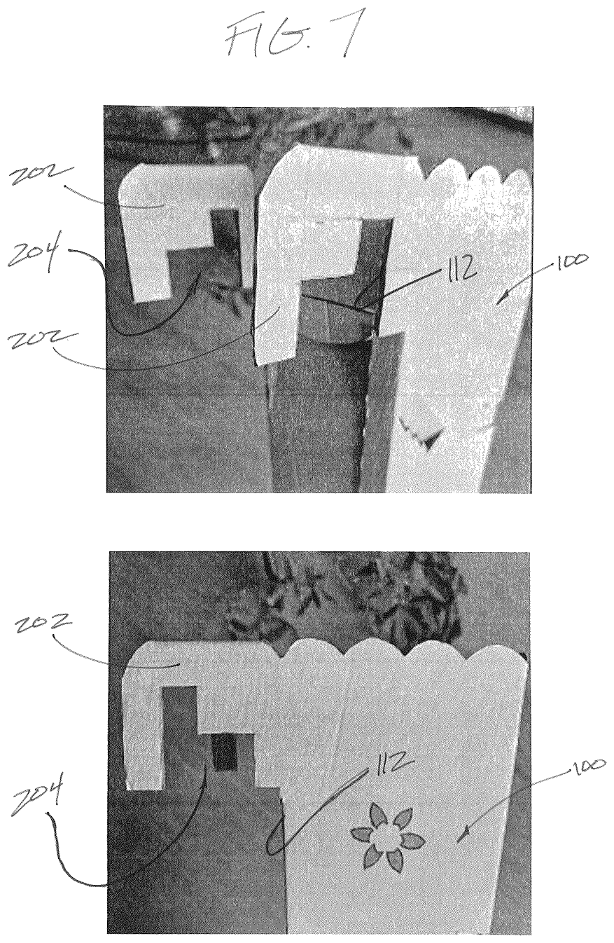

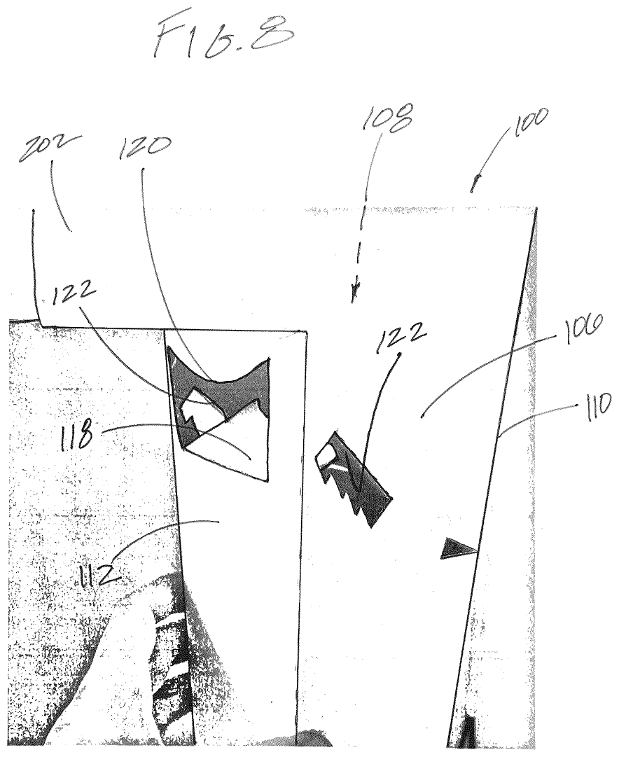

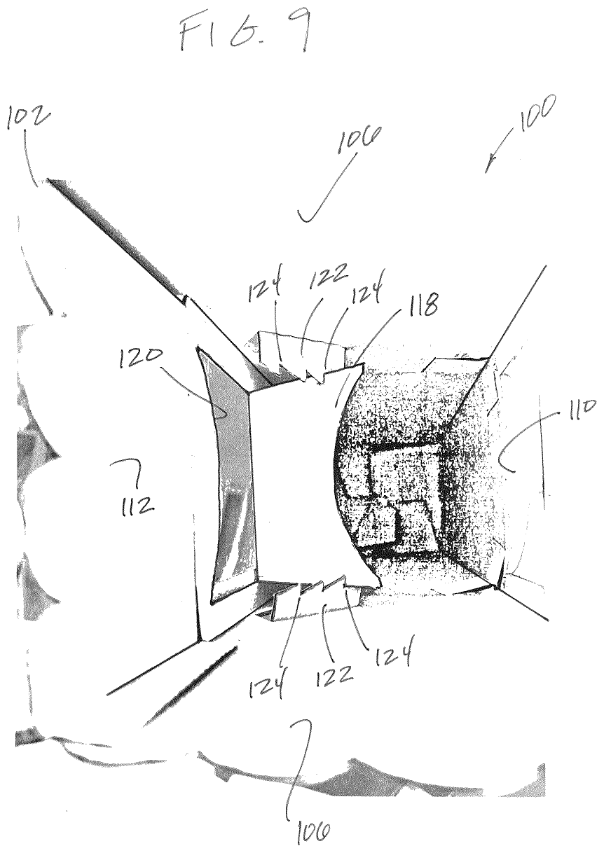

In some embodiments, as shown in FIGS. 8-9, the positioning mechanism 118 may be formed from a portion of the flower holder's front side 112. For example, as shown in FIG. 8, the front side 112 may include a cutline 120 that defines the general shape (i.e., its outline) of the positioning mechanism 118. The cutline 120 may leave an uncut portion (e.g., a lower portion that may be scribed or perforated) such that the positioning mechanism 118 may be formed as a flap folded inward about the uncut portion and into the flower holder's inner volume 108.

In some embodiments, as shown in FIG. 9, once the positioning mechanism 118 is folded into the inner volume 108, the angle of its inward fold may be set and secured by one or more side locking members 122 (e.g., one locking member 122 on either side of the positioning mechanism 118). The locking members 122 may be similarly formed as inward folded flaps cut out from the sides 106 of the flower holder body 100 as shown, and may include one or more notch settings 124, with each notch setting 124 designed to set and lock the positioning mechanism 118 at a particular angle. By setting and locking the positioning mechanism 118 at a particular angle, the distance that the positioning member 118 may extend into the flower holder's inner volume 108 may be set.

As shown in FIG. 9, the distal end of the positioning mechanism 118 may extend towards the flower holder's back side 110 thereby pushing any flowers within the flower holder body 100 in this general direction. In addition, because the positioning mechanism 118 may be locked, the flowers may be held in place in this position during use. In some embodiments, as shown in FIGS. 8-9, the upper portion of the cutline 120 may include a convex curvature thereby forming a corresponding concave curvature at the distal end of the positioning mechanism 118. This concave curvature may encircle a portion of the flowers and aid in the positioning of them at the back side 110 of the flower holder 100.

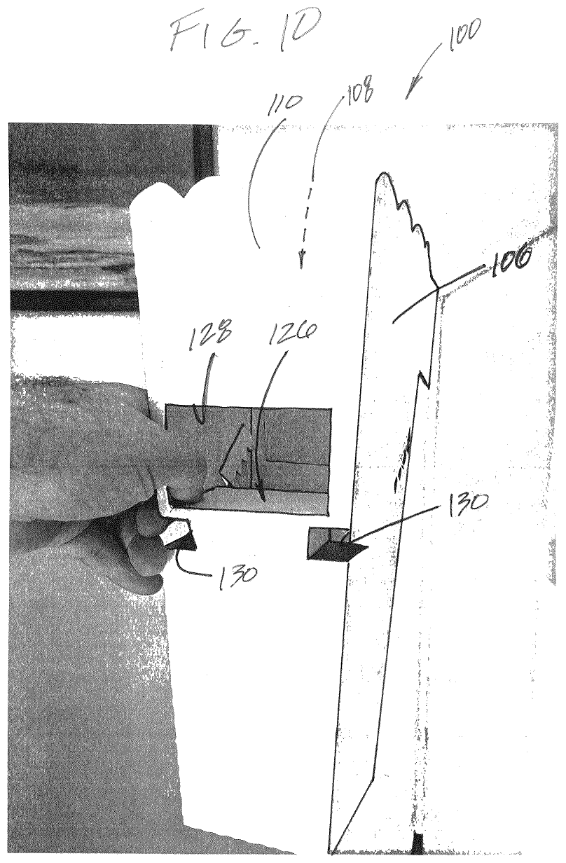

In some embodiments, as shown in FIG. 10, the flower holder body 100 may include an inner shelf 126. The inner shelf 126 may be used to hold potted plants or other items that are not tall enough to be supported by the bottom 104 of the holder 100 when placed therein. In some embodiments, the inner shelf 126 may be formed in a similar fashion as the positioning member 118, i.e., as a flap formed from a portion of the flower holder 100 using a cutline 128. In some embodiments, the cutline 128 may be formed in the back side 110 of the flower holder body 100 such that the resulting inner shelf 126 extends into the holder's inner volume 108 from this side, but it is understood that the cutline 128 and the resulting shelf 126 may be formed in any suitable side of the holder 100.

In some embodiments, the flower holder body 100 may include one or more shelf support members 130 to support the inner shelf 126 along the vertical axis such that the shelf 126 may support weight placed thereon. In some embodiments, the support members 130 may comprise corner sections formed by corresponding cutlines and pressed inward into the holder's inner volume 108 as shown in FIG. 10. It may be preferable that the corner sections be folded inward to form right angles to maximize the support the members 130 may provide. Other types of support members also may be formed from other portions of the holder 100 using other cutlines.

In some embodiments, one or more portions of the flower holder body 100 may be removed to allow for portions of a potted plant, e.g., lower leaves of an orchid plant, to extend outward and outside the holder's inner volume 108. This may prevent these plant portions from becoming damaged if pressed into the inner volume 108 of the holder 100. For example, upper portions of the holder's sidewalls 106 may be removed as necessary.

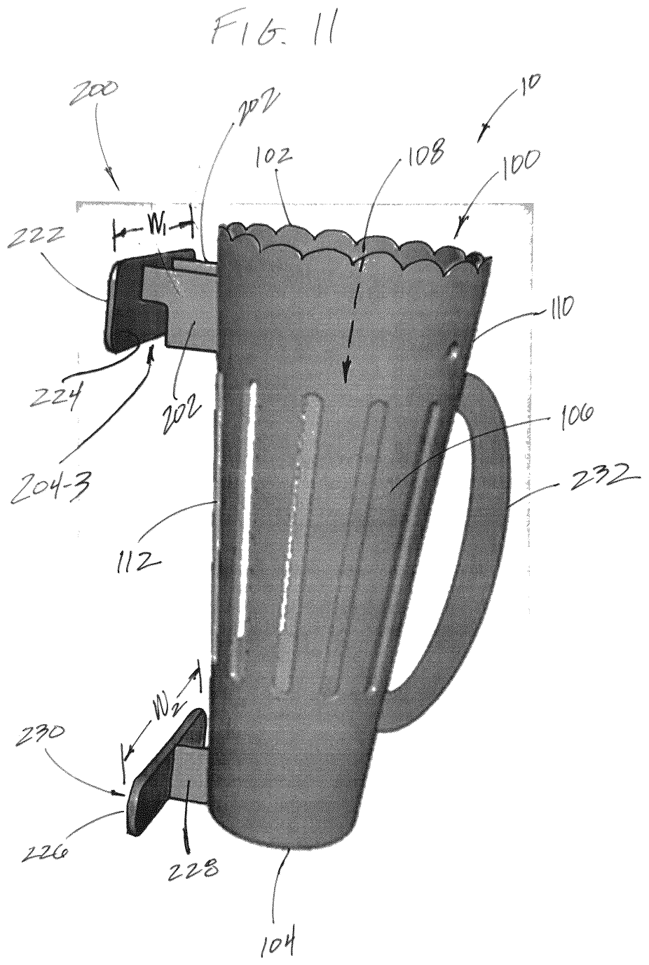

In some embodiments, as shown in FIG. 11, the attachment assembly 200 includes an upper lateral stabilizing member 222 coupled to the distal end of the arms 202. In some embodiments, the length of the arms 202 may be about 3″ to 6″, and more preferably about 4″ to 5″. In some embodiments, the upper lateral stabilizing member 222 may include a plate (or similar structure) with an inner facing surface 224 to which the distal end of the arms 202 are attached. A notch 204-3 may be formed at the junction between the distal end of each arm 202 and the stabilizing member's inner surface 224 with the proximal sidewall and the ceiling of the notch 204-3 formed in the body of the arm 204-3 and the distal sidewall of the notch 204-3 formed by the stabilizing member's inner facing surface 224. In this way, when the support structure S (e.g., the top lip of the car seat back pocket) is received into the notch 204-3, the stabilizing member's inner facing surface 224 may generally rest against the inner surface of the support structure S, thereby providing side-to-side lateral support to the flower holder body 100. In some embodiments, the width W1 of the upper stabilizing member 222 may be about 3″ to 12″, and preferably about 4″ to 8″, and more preferably about 5″ to 6″.

In some embodiments, as shown in FIG. 11, the flower holder body 100 includes a lower lateral stabilizing member 226 coupled to its front side 112 at or near its bottom end 104. The lower stabilizing member 226 may be coupled to the flower holder body 100 via a stabilizing beam 228 extending outward from the holder body 100 (e.g., 1″-3″) generally parallel to the arms 202. The lower stabilizing member 226 may include an outer facing surface 230 designed to rest against an outer facing surface of the support structure S, e.g., an outer facing surface of the seat back pocket. In this way, the lower stabilizing member 226 also may provide side-to-side lateral support to the flower holder body 100. In some embodiments, the width W2 of the lower stabilizing member 224 may be about 3″ to 12″, and preferably about 4″ to 8″, and more preferably about 5″ to 6″.

In some embodiments, the flower holder body 100 may include a handle 232, e.g., coupled to its back side 110, for carrying the flower holder assembly 10.

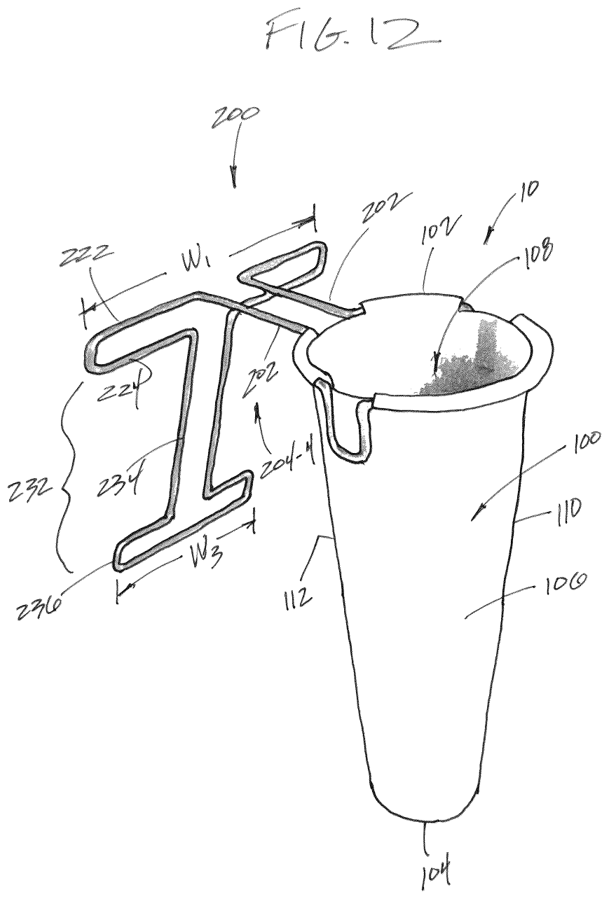

In some embodiments, as shown in FIG. 12, the upper stabilizing member 222 may include a lower extension 232 including a downward extending support member 234 and a lower extension lateral support member 236. This combination may form a notch 204-4 that may receive the support structure S. The lower extension 232 including the support member 234 and the lower extension support member 236 may be received into the seat back pocket along with the upper lateral stabilizing member 222 to provide additional vertical and lateral support to the flower holder body 100. In some embodiments, the upper stabilizing member 222 and its lower extension 232 may comprise wire, metal rod(s), or other suitable materials bent or otherwise formed as generally shown in FIG. 12. In some embodiments, the length of the downward extending support member 232 may be about 4″ to 8″, and more preferably about 5″ to 6″, and the width W3 of the lower extension lateral support member 236 may be about 3″ to 5″.

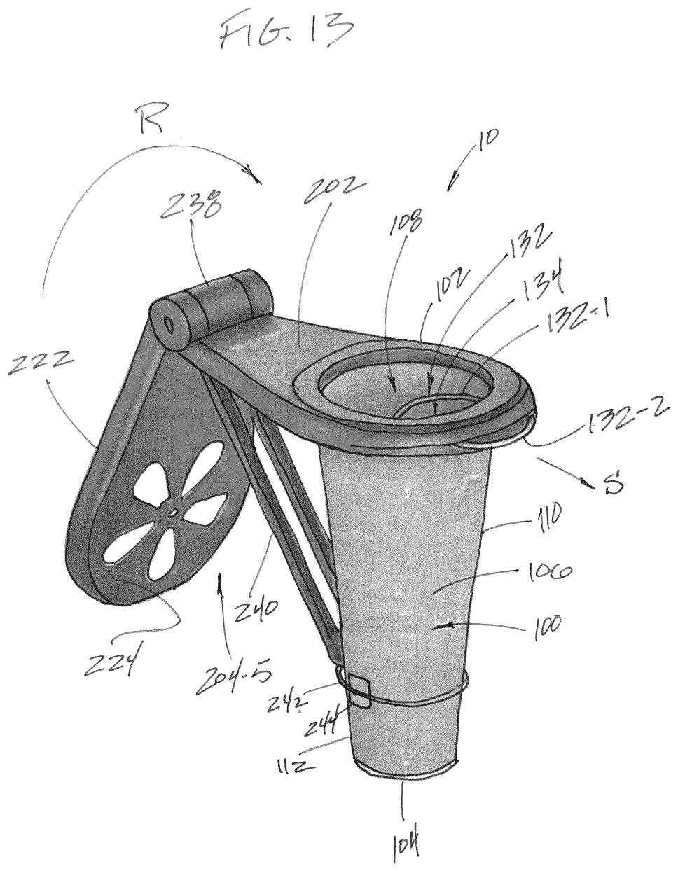

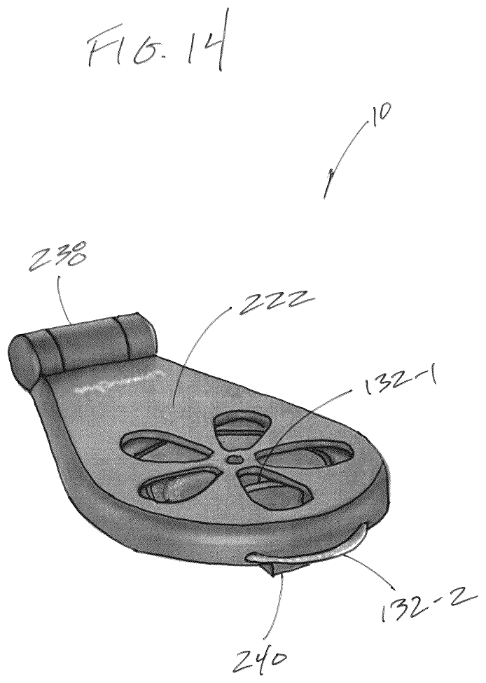

In some embodiments, as shown in FIGS. 13-14, the flower holder assembly 10 may be collapsible (e.g., for stowage). In some embodiments, flower holder body 100 may comprise a flexible material (e.g., cloth, flexible plastic, telescoping sections, etc.) that may collapse. For example, the body sidewalls 106 may generally collapse such that the holder's bottom 104 may be moved upward to be generally abutted against and adjacent the holder's top 102 (and the upper lateral stabilizing member 222 when folded as described below).

In some embodiments, the assembly 10 may include an arm 202 with a proximal end coupled to the flower holder body 100 and with a distal end rotatably coupled to a lateral stabilizing member 222. As shown in FIG. 13, this forms a lower notch 204-5 that may receive a support structure as described in other sections.

In some embodiments, the proximal end of the upper lateral stabilizing member 222 may be rotatably coupled to the distal end of the arm 202 using a rotatable mount 238 such that the member 222 may rotate from an extended position (as shown in FIG. 13) to a collapsed position (as shown in FIG. 14). In some embodiments, the stabilizing member 222 may rotate about the mount 238 in the direction of the arrow R to collapse and in a direction generally opposite the arrow R to extend.

In some embodiments, because the flower holder body 100 may comprise a collapsible material, the assembly 10 may include one or more support legs 240 to provide support to the holder body 100 when the body 100 is extended downward. Each support leg 240 may include a first end movably coupled to the distal end of the arm 202 (e.g., on the underside of the arm 202 using a hinge or a pivot point) and a second end movably coupled to the flower holder body 100, e.g., using a connection loop 242 extending about the outer circumference of the holder body 100. When in the downward position (as shown in FIG. 13), the second end of the leg(s) 240 may be releasably locked in place on the flower holder body 100 by releasably locking the connection loop 242 in a locking tab 244. In this configuration, the support leg(s) 240 may provide support to the extended flower holder body 100. In some embodiments, the leg(s) 240 are held at a predetermined angle (e.g., by the rotatable mount 238) with respect to the vertical when the assembly 10 is in its unfolded configuration. This may prevent a flower bouquet held within the flexible body 100 from swinging during movement of the vehicle (e.g., during braking). In some embodiments, the leg(s) 240 may be held at about 15° to about 35° with respect to vertical, and preferably about 25° to 30°.

When the flower holder body 100 is to be collapsed, the connection loop 242 may be disengaged from the locking tab 244 and moved upwards while collapsing the holder body 100. This may cause the leg(s) 240 to rotate about their distal ends upwards to a collapsed position underneath the arm 202 and the bottom 104 of the flower holder body 100. In some embodiments, the leg(s) 240 may be releasably lockable in this position (e.g., using a latch or other locking mechanism) to generally hold the flower holder assembly 10 in its compact configuration (see FIG. 13).

As described above, when a bouquet of flowers is held within the assembly 10 and configured with the car back seat pocket (e.g., as shown in FIG. 2A), it may be preferable that the bouquet be urged towards the back side 110 of the flower holder body 100 to further position and hold the flower spray away from the back of the car seat. To accomplish this, in some embodiments, the flower holder body 100 may include a loop positioning mechanism 132 that may physically engage the flower bouquet. In some embodiments, the loop positioning mechanism 132 comprises a line, e.g., a string, a chain, a cable, a ribbon, an elongate piece of flexible material such as fabric, and/or any other suitable line.

In some embodiments, as shown in FIG. 13, the loop positioning mechanism 132 may be configured at or near the top 102 back side 110 of the flower holder body 100, with a first loop portion 132-1 looping through the flower holder's inner volume 108 and a second loop portion 132-2 looping across an outer portion of the holder body 100. For example, the loop positioning mechanism 132 may include a loop that passes through left and right holes in the holder's sidewalls 106 or in a top rim of the holder 100. In some embodiments, the first loop portion 132-1 within the inner volume 108 may form an adjustable inner loop portion 134 through which the flower bouquet may be inserted. As such, during use, the flower bouquet may extend through the inner loop portion 134 and down into the inner volume 108 of the flower holder body 100.

With the flower bouquet passing through the inner loop portion 134, the second loop portion 132-2 may be pulled away from the flower holder body 100, e.g., in the direction of the arrow S, such that the inner loop portion 134 becomes reduced in size thereby urging the bouquet of flowers towards the back side 110 of the holder 100. In some embodiments, the loop positioning mechanism 132 may include a releasable locking mechanism (e.g., a sliding tie) on its second loop portion 132-2 that may be used to releasably lock the mechanism 132 in a tightened configuration during the car ride, and that may be released such that the inner loop portion 134 may be expanded and the flower bouquet may be removed when the ride is over.

It is understood that any aspect and/or element of any embodiment of the assembly 10 described herein may be combined with any other aspect and/or element of any other embodiment described herein in any way to form additional embodiments of the assembly 10 all of which are within the scope of the assembly 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A flower holder assembly comprising:
a holder body including an open top and a bottom defining a body longitudinal axis, and a front and a back defining a body inner volume;
one or more arms coupled to and extending outward from the front of the holder body, each one of the one or more arms including a distal end and a first notch in a bottom side of the distal end;
wherein the first notch includes a first notch distal sidewall that defines a first notch longitudinal axis, the first notch longitudinal axis at a notch offset angle with respect to the body longitudinal axis.

2. The flower holder assembly of claim 1 wherein the notch offset angle includes an acute angle with respect to the body longitudinal axis.

3. The flower holder assembly of claim 1 wherein each one of the one or more arms includes a second notch in the bottom side and located between the front of the holder body and the first notch.

4. The flower holder assembly of claim 3 wherein the second notch includes a second notch distal sidewall that defines a second notch longitudinal axis, the second notch longitudinal axis substantially parallel to the holder longitudinal axis.

5. The flower holder assembly of claim 1 wherein the one or more arms are removable from the holder body.

6. The flower holder assembly of claim 1 wherein a portion of the one or more arms pass through the front and the back of the flower holder body.

7. The flower holder assembly of claim 1 further comprising a positioning member within the body inner volume that urges a flower bouquet held within the holder inner volume towards the back of the flower holder body.

8. The flower holder assembly of claim 7 wherein the positioning member includes a portion of the front of the holder body folded inward into the holder inner volume and/or a portion of the back of the holder body folded inward into the holder inner volume.

9. The flower holder assembly of claim 7 wherein the positioning member includes a line.

10. The flower holder assembly of claim 1 further comprising a shelf within the body inner volume substantially perpendicular to the body longitudinal axis.

11. The flower holder assembly of claim 1 wherein the holder body is collapsible.

12. The flower holder assembly of claim 1 wherein the one or more arms is retractable.

13. A flower holder assembly comprising:
a holder body including an open top and a bottom defining a body longitudinal axis, and a front and a back defining a body inner volume;
one or more arms coupled to and extending outward from the front of the holder body, each one of the one or more arms including a distal end and a first notch in a bottom side of the distal end;
wherein the first notch includes a first notch distal sidewall that is at least 3″ from the front of the holder body.

14. The flower holder assembly of claim 13 wherein the first notch includes a first notch distal sidewall that defines a first notch longitudinal axis, the first notch longitudinal axis at an acute angle with respect to the body longitudinal axis.

15. The flower holder assembly of claim 13 wherein each one of the one or more arms includes a second notch in the bottom side and located between the front of the holder body and the first notch.

16. The flower holder assembly of claim 15 wherein the second notch includes a second notch distal sidewall that defines a second notch longitudinal axis, the second notch longitudinal axis substantially parallel to the holder longitudinal axis.

17. The flower holder assembly of claim 13 wherein the one or more arms are removable from the holder body.

18. The flower holder assembly of claim 13 wherein a portion of the one or more arms pass through the front and the back of the flower holder body.

19. The flower holder assembly of claim 13 further comprising a positioning member within the body inner volume that urges a flower bouquet held within the holder inner volume towards the back of the flower holder body.

20. The flower holder assembly of claim 13 wherein the holder body is collapsible, and the one or more arms is retractable.
